(19) United States
(12) Patent Application Publication
(10) Pub. No.: US 2025/0363287 A1
(43) Pub. Date: Nov. 27, 2025

(54) SYSTEMS AND METHODS FOR FORM GENERATION USING ARTIFICIAL INTELLIGENCE BASED DATA CONFIGURATION MIGRATION

(71) Applicant: CDK GLOBAL, LLC, Hoffman Estates, IL (US)

(72) Inventors: Northon Rodrigues, Oregon City, OR (US); Ethan Heusser, Portland, OR (US); Mahesh Shanmugasundaram, Austin, TX (US)

(21) Appl. No.: 18/670,319

(22) Filed: May 21, 2024

(51) Int. Cl. G06F 40/103

(52) U.S. Cl. CPC G06F 40/103

(57) ABSTRACT

Methods and systems for automatic form conversion are disclosed. An example method includes: receiving a plurality of client forms from a plurality of client systems; evaluating a client form structure comprising one or more generic fields for a client system of the plurality of client systems in a form specific language by an artificial intelligence (AI) model, including analyzing one or more client forms from the client system by the AI model; looking up a client configuration of the client system by the AI model; and determining a relational map between the one or more generic fields in the client form structure for the client system and one or more standard fields in a standard form structure.

### BACKGROUND

Legacy software is often restricted in its usage of database fields. For example, such software includes predetermined fields. In order to overcome the database entries shortage so prevalent in legacy software, developers of said software often created generic fields that could be used for many different purposes.

In order to provide clients greater flexibility in storing and retrieving data, a database management software provides a generic field that stores an item not included in the predetermined fields and a number field that stores its correspondence amount (e.g., fee and/or cost, a number of items, etc.) The generic field and its corresponding number field can be used to store generic data that requires customized logic to map its contents for each of its instances. These generic fields storing common items and their corresponding number fields may be mapped differently on a same form and/or template across two or more entities (e.g., clients, customers, dealerships).

### BRIEF DESCRIPTION OF THE DRAWINGS

FIG. 1A illustrates an example flowchart of a method of automatic form conversion in accordance with examples described herein.

FIG. 1B illustrates an example flowchart of operation of automatic form conversion in accordance with examples described herein.

FIG. 1C illustrates an example flowchart of operation of printing an automatically converted form in accordance with examples described herein.

FIG. 2A illustrates a schematic diagram of a system including an automatic form conversion system in accordance with examples described herein.

FIG. 2B shows a comparison of form(s) in client form structure across client systems in accordance with examples described herein.

FIG. 3 is a schematic illustration of a computer system that may be used to implement systems and methods in accordance with examples described herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Certain details are set forth herein to provide an understanding of described embodiments of technology. However, other examples may be practiced without various of these particular details. In some instances, well-known computer system components, artificial intelligence (AI) techniques, text level language processing particulars, circuits, control signals, timing protocols, and/or software operations have not been shown in detail in order to avoid unnecessarily obscuring the described embodiments. Other embodiments may be utilized, and other changes may be made, without departing from the spirit or scope of the claims.

While examples are described herein in the context of automotive dealerships, it is to be understood that other text templates and forms may be analyzed using techniques described herein, and that systems and techniques described herein may be used to identify and convert other text documents instead of or in addition to forms and/or templates.

The present disclosure provides various embodiments of automatic form conversion using AI techniques. Using an AI engine with machine learning, how proprietary generic variables are used across a plurality of client systems (e.g., legacy systems, such as dealer management systems (DMSs)) may be determined with high accuracy. In the automatic form conversion, an AI model may evaluate a client form structure including generic fields for a client system of the plurality of client systems in a form specific language (e.g., Printer Control Language (PCL)), where the AI model may analyze one or more client forms from the client system. The AI model may also look up a client configuration (e.g., an indirect configuration) of the client system.

Using the information from the forms and the client configuration, a relational map between the generic fields in the client form structure for the client system and corresponding standard fields in a standard form structure may be determined.

In some examples, the AI model with a machine learning algorithm may be trained to determine meaning and context associated with generic fields on a per-client system basis based on the forms and the client configuration. Thus, the AI model may learn the meaning of each field in the client form structure for each client system of the plurality of client systems and automatically map a generic field name or a generic text string in each generic field of the client form structure to a standard field name or a standard text string in each standard field in a standard form structure. Thus, contents in a client form structure may be migrated into the standard form structure across the plurality of client systems.

Using the automatic form conversion disclosed herein, standardized forms may be created by adapting generic fields in a form in the client form structure on a per-client system basis at time of accessing (e.g., printing, displaying, processing, etc.) the form. The automatic form conversion system with the AI model may process a large quantity of client forms to create mapping of generic fields of the client form structure for a plurality of client systems and standard fields of the standard form structure without causing manual labor or programming of humans. Thus, mapping may be performed in a reasonably short time without human errors. When a new form is processed by the automatic form conversion system, the AI model of the automatic conversion system may further learn from the new form, thus potentially improving the accuracy of automatic conversion as the AI model processes the new form.

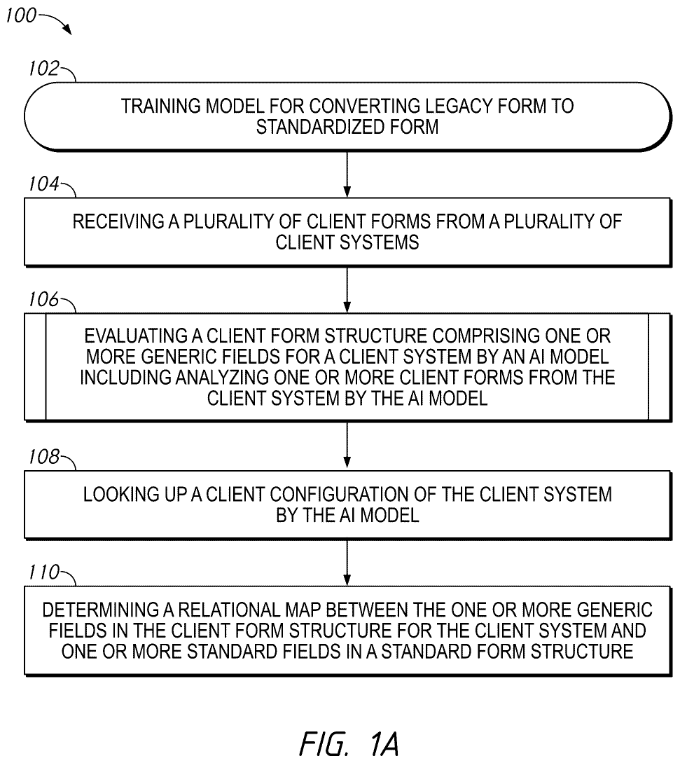

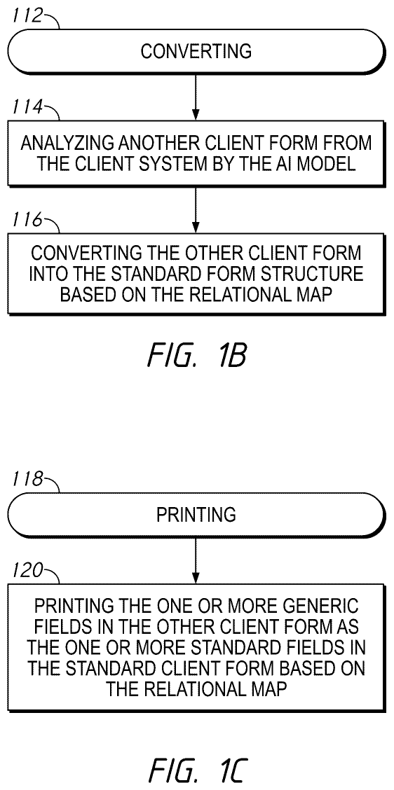

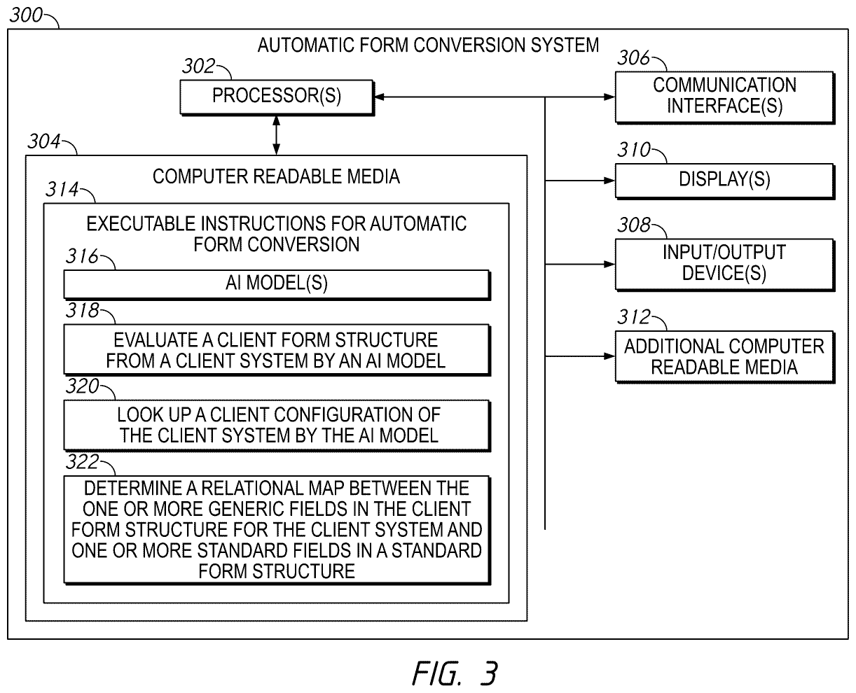

FIG. 1A illustrates an example flowchart of a method 100 of automatic form conversion in accordance with examples described herein. Although the example method 100 depicts a particular sequence of operations, the sequence may be altered without departing from the scope of the present disclosure. For example, some of the operations depicted may be performed in parallel or in a different sequence that does not materially affect the function of the method 100. In some examples, the method 100 may be performed by one or more processor(s) 302 of an automatic form conversion system 300 of FIG. 3. In other examples, different components of an example device or system that implements the method 100 may perform functions at substantially the same time or in a specific sequence. In some examples, the method 100 of automatic form conversion may include a training process of an AI model that may perform automatic form conversion.

According to some examples, the method 100 includes operation 102 training model for converting a legacy form on a client system to a standardized form. In some examples, legacy forms for a plurality of client systems may share an identical or common client form structure and/or client form template, where concrete fields may store the same specific items/parameters across the plurality of client systems while generic fields may store items defined by each client system. For example, an item stored in a generic field for one client system may be stored in another generic field for another client system. For each client system, a relational map for the item between a generic field storing the item of the client form structure and a standard field storing the item of the standard form structure may be determined by the AI model, as the AI model may be trained using its machine learning algorithm receiving client forms and a client configuration from each client system. After the automatic form conversion, the same item migrated from legacy forms from a plurality of client systems may be stored in a standard field designated for the item.

According to some examples, the method 100 includes receiving a plurality of client forms from a plurality of client systems at operation 104. In some examples, the plurality of client systems may be preexisting legacy systems, such as DMSs in the context of the automotive industry. In some examples, the plurality of forms may be described in a form specific language, such as PCL.

According to some examples, the method 100 includes evaluating a client form structure including one or more generic fields for a client system by an AI model at operation 106. In some examples, such evaluating the client form structure may include analyzing one or more client forms from the client system by the AI model. In some examples, the one or more client forms may be included in the plurality of client forms received from the client system.

The relationship of field (location) in a form and an item stored in the field may be analyzed in the evaluation of the operation 106. In some examples, the plurality of client forms may have a common client form structure across the plurality of client systems. In some examples, the plurality of client systems may include client systems, where each client system may be identified as a client system field in the client form structure. In some examples, the common client form structure may include concrete fields and generic fields. Concrete fields may store the same specific items/parameters across the plurality of client systems. Generic fields may store items defined by each client system. In some examples, analyzing the one or more client forms from the client system includes identifying one or more generic fields configured to represent one or more common items in the client form structure by the AI model. In general, generic fields may store common items across a plurality of client systems and/or unique items for each client system; however, an item stored in a generic field for one client system may be stored in another generic field for another client system, even though these client systems may share a common client form structure. Thus, which generic field may store which common item may depend on each client system.

According to some examples, the method 100 includes looking up a client configuration of the client system by the AI model at operation 108. For example, the common items may be represented using different text strings for different client systems. In some examples, to handle such text strings representing the common items, the AI model may determine at least one of meaning and context associated with each generic field of the one or more generic fields based on the client configuration. In some examples, determining the at least one of meaning and context may include analyzing one or more client text strings in each generic field based on the client configuration; and associating each generic field with the at least one of meaning and context represented by the one or more text strings. The generic field may be associated with a standard field through the associated at least one of meaning and context also associated with the standard field. For example, county information and county tax information may be included in separate fields including a generic field “CountyTax” in a client form for one client system based on one client configuration. The county tax information may be included in another generic field “(Name of County) Tax” in another client form for another client system based on another client configuration. These generic fields may be associated with a standard field representing a county tax in the standard form structure. As described herein, based on the meaning and context of texts representing a common item in different generic fields, such generic fields storing the common item across client forms of different client systems may be associated with a standard field representing the common item in the standard form structure.

According to some examples, the method 100 includes determining a relational map between the one or more generic fields in the client form structure for the client system and one or more standard fields in a standard form structure at operation 110. In some examples, such determining the relational map includes mapping between the one or more generic fields in the client form structure and corresponding one or more standard fields configured to represent the one or more common items in the standard form structure.

Thus, in order to build standard forms, generic fields in existing forms for one or more client in a common form structure may be dynamically replaced with concrete field equivalents. In some examples, standardizing forms may be performed by an AI engine with machine learning. For instance, in some examples, generic fields storing common items and their corresponding number fields may be mapped differently on a same form and/or template across a plurality of client systems that belong to a plurality of entities (e.g., clients, customers, dealerships). Thus, the flowchart of the method 100 demonstrates how AI models may be used to analyze generic fields storing items with their corresponding numeric fields in an existing form for each client and map or associate these generic fields to standard fields of a standard form structure to create a standardized form.

FIG. 1B illustrates an example flowchart of operation 112 of automatic form conversion in accordance with examples described herein. Although the example operation 112 depicts a particular sequence of instructions, the sequence may be altered without departing from the scope of the present disclosure. For example, some of the instructions depicted may be performed in parallel or in a different sequence that does not materially affect the function of the operation 112. In some examples, the operation 112 may be performed by the one or more processor(s) 302 of the automatic form conversion system 300. In other examples, different components of an example device or system that implements the operation 112 may perform functions at substantially the same time or in a specific sequence. In some examples, the operation 112 includes an automatic form conversion process performed by the AI model trained by the method 100. In some examples, the operation 112 may be performed as a portion of the method 100 and a new form processed by the operation 112 may further cause the one or more processor(s) 302 to train the AI model.

According to some examples, the operation 112 of automatic form conversion may include analyzing another (e.g., additional) client form from the client system by the AI model of automatic form conversion at operation 114. The AI model may have been trained using the method 100. In some examples, the operation 112 may be performed by the one or more processor(s) 302 of the automatic form conversion system 300.

According to some examples, the operation 112 of automatic form conversion may include converting the other (additional) client form into the standard form structure based on the relational map for the client system at operation 116. The relational map may have been obtained through the process of the method 100. Additionally or alternatively, the relational map for the client system may be further modified or created based on the analysis of the other (additional) client form, when the other (additional) client form may include one or more generic fields not previously analyzed or relationship between the one or more generic fields and any of standard fields have not been identified or recognized by the AI model with statistical significance (e.g., numbers of appearance of common items in the generic fields in the client forms analyzed prior to creation of the relational map have not been sufficient to make statistical inference). Thus, the one or more processor(s) 302 of the automatic form conversion system 300 may keep updating the relational map for the client system based on the other (additional) client form while converting the other (additional) client form into the standard form.

FIG. 1C illustrates an example flowchart of operation 118 of printing an automatically converted form in accordance with examples described herein. Although the example operation 118 depicts a particular sequence of instructions, the sequence may be altered without departing from the scope of the present disclosure. For example, some of the instructions depicted may be performed in parallel or in a different sequence that does not materially affect the function of the operation 118. In some examples, the operation 118 may be performed by the one or more processor(s) 302 of the automatic form conversion system 300. In other examples, different components of an example device or system that implements the operation 118 may perform functions at substantially the same time or in a specific sequence. In some examples, the operation 118 may be performed by the AI model trained by the method 100.

According to some examples, the method includes printing the one or more generic fields in the other client form as the one or more standard fields in the standard client form based on the relational map at operation 120. As described herein, client forms including generic fields for each client system of the plurality of client systems may be described in a form specific language (e.g., PCL). Once the conversion of a client form into a corresponding standard form may be performed at the operation 112, printing the one or more generic fields in the other client form as the one or more standard fields in the standard client form based on the relational map at operation 120. In some examples, the converted corresponding standard form may be described using the PCL, and such form may be printed out as the standard form. Generic fields of the other (additional) client form may be printed as standard fields of the standard client form, based on the relational map.

Using the automatic form conversion disclosed herein along with FIGS. 1A-IC, standardized forms may be created by adapting generic fields of client forms in the client form structure on a per-client system basis into standard fields in a standard form at time of accessing (e.g., printing, displaying, processing, etc.) the client forms.

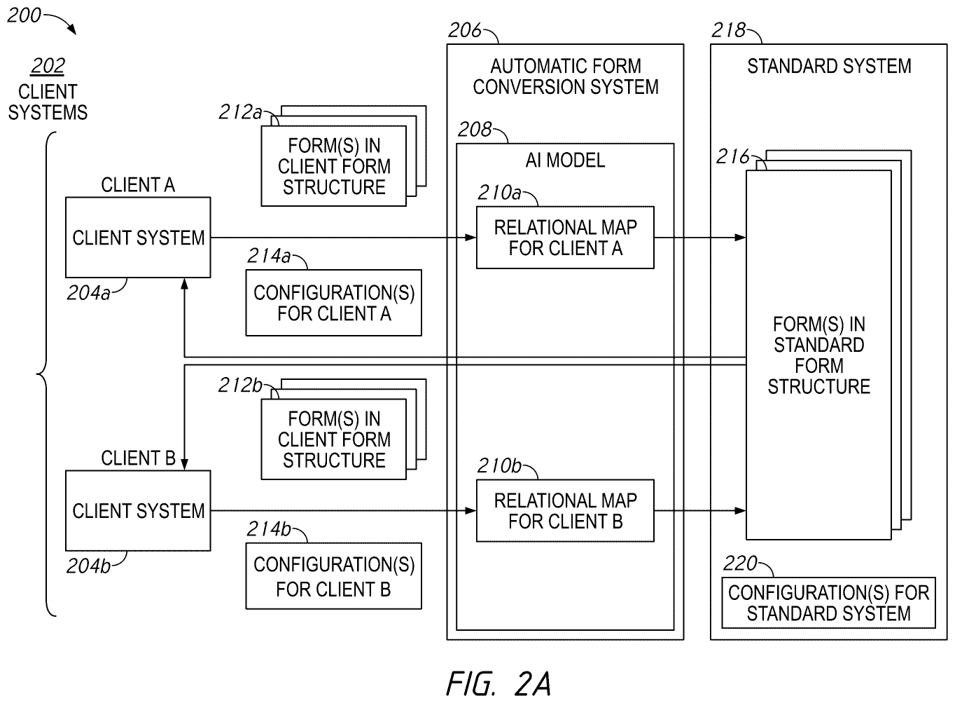

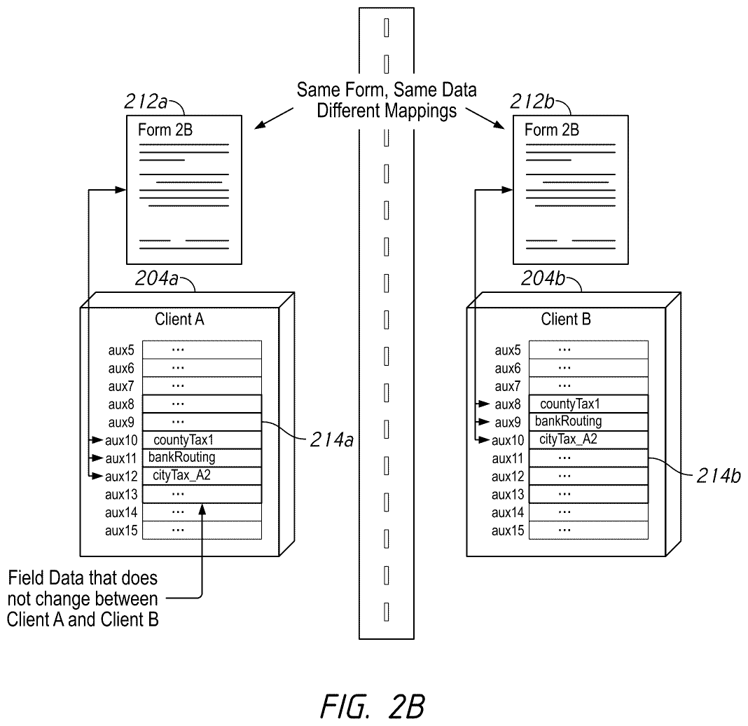

FIG. 2A illustrates a schematic diagram of a system 200 including an automatic form conversion system 206 in accordance with examples described herein. In some examples, the automatic form conversion system 206 may be a cloud-based field adapter. The system 200 includes one or more client systems 202 for one or more clients, a standard system 218 and an automatic form conversion system 206. In some examples, the one or more client systems 202 may include DMSs for a plurality of dealers included in a datacenter, for example. For example, the one or more client systems 202 may include a client system 204a for Client A (e.g., Dealer A) and a client system 204b for Client B (e.g., Dealer B). In some examples, the automatic form conversion system 206 may include an AI model 208. In some examples, the AI model 208 may include one or more relational maps for the one or more clients, including a relational map for client A 210a and a relational map for client B 210b. In some examples, the relational maps 210a and 210b may function as a legacy bridge/adaptor. The automatic form conversion system 206 may convert form(s) in a client form structure from the one or more client systems 202 to form(s) in standard form structure 216 based on the one or more relational maps. In some examples, the standard system 218 may store configuration(s) for standard system 220 and the form(s) in standard form structure 216 for printing, displaying, or further processing, such as obtaining data from each form or modifying data in each form.

In some examples, the automatic form conversion system 206 may perform the method 100 to obtain a relational map for each client system of the client systems 202. In some examples, the automatic form conversion system 206 may receive the form(s) in a client form structure from each of the one or more client systems 202. In some examples, the automatic form conversion system 206 may store the configuration(s) for each of the one or more client systems 202. In some examples, the configuration(s) for each of the one or more client systems 202 may be stored prior to receiving the form(s) in the client form structure. In some examples, the configuration(s) for each of the one or more client systems 202 may be received together with form(s) in the client form structure.

The AI model 208 may evaluate a client form structure including one or more generic fields for each client system of the one or more client systems in a form specific language. In some examples, the AI model 208 may analyze the one or more client forms from each client system of the one or more client systems. Then the AI model 208 may look up the client configuration of each client system. The AI model 208 may determine a relational map between the one or more generic fields in the client form structure for the client system and one or more standard fields in a standard form structure. Based on the relational map, the AI model 208 may convert the forms from the client systems 202 into form(s) in standard form structure 216. The form(s) in standard form structure 216 may be stored in the standard system 218.

FIG. 2B shows a comparison of form(s) in client form structure 212a and form(s) in client form structure 212b across client systems 204a and 204b in accordance with examples described herein. The form(s) 212a and 212b may have a common client form structure; however, common items may be stored in different generic fields across the form(s) 212a and 212b.

In some examples, the automatic form conversion system 206 may receive form(s) in client form structure 212a for Client A from the client system 204a. In some examples, the automatic form conversion system 206 may also receive configuration(s) 214a for the client system 204a from the client system 204a. In some examples, the automatic form conversion system 206 may store the configuration(s) 214a for the client system 204a prior to receiving the form(s) in client form structure 212a from the client system 204a.

The AI model 208 may evaluate a client form structure including one or more generic fields for the client system 204a. In some examples, the client form structure including one or more generic fields for the client system 204a may be in a form specific language, such as PCL. In some examples, the AI model 208 may analyze the form(s) in client form structure 212a. For example, generic field “aux10” may store item “countyTax1” based on a county in an address of a customer stored in a concrete field of the form 212a, generic field “aux11” may store item bankRouting indicating a routing number of a bank account of the customer of the form 212a, and generic field “aux12” may store item “cityTax_A2” based on a city in the address of the customer in the concrete field of the form 212a.

Then the AI model 208 may look up the configuration(s) 214a for Client A from the client system 204a. The AI model 208 may determine a relational map for client A 210a between the one or more generic fields in the client form structure for the client system 204a and one or more standard fields in a standard form structure. Thus, generic fields aux10-12 may be converted into corresponding standard fields of the standard form structure in each of form(s) in standard form structure 216.

In some examples, the automatic form conversion system 206 may receive form(s) in client form structure 212b for Client B from the client system 204b. In some examples, the automatic form conversion system 206 may also receive configuration(s) 214b for the client system 204b from the client system 204a. In some examples, the automatic form conversion system 206 may store the configuration(s) 214b for the client system 204b prior to receiving the form(s) in client form structure 212b from the client system 204b.

The AI model 208 may evaluate a client form structure including one or more generic fields for the client system 204b. In some examples, the client form structure including one or more generic fields for the client system 204b may be in a form specific language, such as PCL. In some examples, the AI model 208 may analyze the form(s) in client form structure 212b. For example, generic field “aux8” may store item “countyTax1” based on a county in an address of a customer stored in a concrete field of the form 212b, generic field “aux9” may store item “bankRouting” indicating a routing number of a bank account of the customer of the form 212b, and generic field “aux10” may store item “cityTax_A2” based on a city in the address of the customer in the concrete field of the form 212b.

Then the AI model 208 may look up the configuration(s) 214b for Client B from the client system 204b. The AI model 208 may determine a relational map for client B 210b between the one or more generic fields in the client form structure for the client system 204b and one or more standard fields in a standard form structure. Thus, generic fields aux8-10 may be converted into corresponding standard fields of the standard form structure in each of form(s) in standard form structure 216.

As described herein, generic fields aux10-12 of the form(s) in client form structure 212a and generic fields aux8-10 of the form(s) in client form structures 212b may store common items, and these may be converted into standard fields storing items “countyTax1,” “bankRouting,” and “cityTax_A2,” respectively.

Thus, using information from the forms and the client configuration, the AI model with the machine learning algorithm may determine meaning and context associated with generic fields on a per-client system basis. For example, on another client system, the AI model may determine that generic field “aux3” may store the item “countyTax1,” based on the training.

In some examples, an address of a customer stored in the concrete field may be used. In some examples, an expression for processing the forms may use both concrete fields with generic fields. In order to build standard forms, all generic fields may be replaced with concrete field equivalents in standard forms.

As an AI model with machine learning and/or deep learning-based approaches continues to be trained, improved form fields conversion will encourage form standardization. Examples of multi-step processes described herein facilitate interpretability of generic fields in a client form structure by training an AI model with machine learning and/or deep learning algorithm. Thus, based on forms from each client system and configuration(s) for each client system, a relational map between generic fields in existing forms for each client system of a client form structure and standard fields in standard forms of a standard form structure for each client system may be determined. The performance of the method enables overall improved accuracy in form in comparison to conventional manual form conversion, and faster processing of the form conversion without substantive human processing.

FIG. 3 is a schematic illustration of an automatic form conversion system 300 that may be used to implement systems and methods in accordance with examples described herein. The automatic form conversion system 300 includes one or more processor(s) 302, and one or more computer readable media 304 that may store executable instructions for automatic form conversion 314. The automatic form conversion system 300 may further include input/output device(s) 308, communication interface(s) 306, one or more additional computer readable media 312, and/or one or more display(s) 310. The executable instructions for automatic form conversion 314 may include AI model(s) 316, executable instructions 318 for evaluating a client form structure from a client system by an AI model and executable instructions for executing and/or training one or more AI model(s) 316, executable instructions 320 for looking up a client configuration of the client system by the AI model, and executable instructions 322 for determining a relational map between the one or more generic fields in the client form structure for the client system and one or more standard fields in a standard form structure.

The automatic form conversion system 300 may receive forms, such as the form(s) in a client form structure, from each of the one or more client systems 202 of FIG. 2A at the communication interface(s) 306. In some examples, the automatic form conversion system 300 may store configuration(s) for each of the one or more client systems, such as the configurations 214a and 214b of FIG. 2A in the additional computer readable media 312. In some examples, the configuration(s) may be stored in the additional computer readable media 312 prior to receiving the form(s) in the client form structure. In some examples, the configuration(s) for each of the one or more client systems may be received together with form(s) in the client form structure at the communication interface(s) 306 and stored in the additional computer readable media 312.

The processor(s) 302 may perform the executable instructions 318 to evaluate a client form structure including one or more generic fields for each client system of the one or more client systems in a form specific language by the AI model(s) 316. In some examples, the processor(s) 302 may perform the executable instructions 320 to analyze the one or more client forms from each client system of the one or more client systems by the AI model(s) 316. Then the processor(s) 302 may perform executable instructions 322 to look up the client configuration of each client system by the AI model(s) 316. Through performing the executable instructions 318, 320, and 322, the AI model(s) 316 may be trained. The AI model(s) 316 may determine a relational map between the one or more generic fields in the client form structure for the client system and one or more standard fields in a standard form structure.

The automatic form conversion system 300 may be implemented, for example, using one or more computers, servers, smart phones, smart devices, tablets, and/or appliances. The automatic form conversion system 300 may be coupled to and/or in communication with a source or storage of forms, such as the client systems 202 of FIG. 2A. The automatic form conversion system 300 may convert existing forms in a client form structure into standard forms in a standard form structure. The automatic form conversion system 300 of FIG. 3 includes one or more processor(s) 302 and one or more computer readable media 304. The computer readable media 304 may include executable instructions for automatic form conversion 314. In some embodiments, the automatic form conversion system 300 may be physically coupled to a source or storage of forms, such as the client systems 202 of FIG. 2A. In other embodiments, the computer system may not be physically coupled to a source or storage of forms, such as the client systems 202 of FIG. 2A, but may be in communication with a source or storage of forms, such as the client systems 202 of FIG. 2A. In some examples, the automatic form conversion system 300 may include communication interface(s) 306 that may be in communication with a source of the 3D image data, such as a microscope or other imaging system, or with storage containing one or more 3D image data sets.

Computer systems, such as automatic form conversion system 300 of FIG. 3, may include one or more processor(s) 302. Any kind and/or number of processors may be present, including one or more central processing unit(s) (CPUs), graphics processing units (GPUs), other computer processors, mobile processors, digital signal processors (DSPs), field programmable gate arrays (FPGAs), application specific integrated circuits (ASICs), microprocessors, computer chips, and/or processing units configured to execute machine-language instructions and process data, such as executable instructions for identification of 2D regions of interest.

Computer systems, such as the automatic form conversion system 300 of FIG. 3, may further include computer readable media 304. Any type or kind of media may be present, including memory and/or storage. Examples include read only memory (ROM), random access memory (RAM), solid state drive (SSD), secure digital card (SD card), hard drive, network-attached storage, etc. Computer systems, such as the automatic form conversion system 300 of FIG. 3, may further include additional computer readable media 312. While each single box is depicted as computer readable media in FIG. 3, any number of memory and/or storage devices may be present. The computer readable media, such as the computer readable media 304 and/or the additional computer readable media 312 may be in communication with (e.g., electrically connected to) the processor(s) 302.

The computer readable media 304 may store executable instructions for execution by the processor(s), such as executable instructions for automatic form conversion 314. The executable instructions for automatic form conversion 314 may include executable instructions for executable instructions 318 from one or more 3D data sets, including features described herein.

The executable instructions for automatic form conversion 314 may additionally or instead include instructions for executing and/or training one or more AI model(s) 316. In some examples, training of the AI model(s) 316 using client forms and use of the AI model(s) 316 to analyze a new client form for conversion may be performed using a same computer system, such as the automatic form conversion system 300 of FIG. 3. In other examples, one or more of the AI model(s) may be trained using a different computer system, and data encoding the trained AI model(s) 316 may be stored in the computer readable media 304 of the automatic form conversion system 300 of FIG. 3 and may be used to analyze a new client form for conversion.

Training of the AI model(s) may be performed using any of a variety of techniques including, but not limited to, supervised learning, unsupervised learning, clustering, and/or reinforcement learning.

In some examples, the AI model(s) may be implemented using one or more machine classifiers, such as one or more deep learning models, neural networks, and/or machine learning models. Examples of machine learning models may include convolutional neural networks (CNNs), support vector machines (SVMs) (e.g., radial basis function (RBF) kernel SVMs), random forest classifiers (RFCs), transformers, language models, and/or k-means clustering.

The automatic form conversion system 300 of FIG. 3 may include additional components, not all of which are necessarily depicted in FIG. 3. Example of additional components may include one or more communication interface(s) 306. In some examples, the one or more communication interface(s) 306 may include wireless communication interfaces such as a WiFi, Bluetooth, network interface, cellular interface, wired communication interfaces such as serial buses (e.g., universal serial bus) or parallel data interface, and/or other communications interface. The communication interface(s) 306 may be used to receive form(s) in client form structure in some examples. The communication interface(s) 306 may be used to provide standard form(s) in standard form structure to another computer system, such as the client system where each form before conversion was provided, for review and/or editing by another process (e.g., by a human reviewer/editor, such as a dealer representative). The automatic form conversion system 300 may include one or more display(s) 310. The display(s) 310 may be used, for example, to display the form. The automatic form conversion system 300 may include one or more input and/or output device(s) 308 including, but not limited to, one or more printers, touchscreens, mice, keyboards, and/or cameras. The printer may be operated by a user of the automatic form conversion system 300 and/or the client system to print the form(s) in standard form structure. The automatic form conversion system 300 may include and/or be in communication with additional computer readable media 312 that may provide temporary data to be used during processing, or permanent data to be stored for record or presented to a user.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples, the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

What is claimed is:

1. A method of automatic form conversion comprising:
receiving a plurality of client forms from a plurality of client systems;
evaluating a client form structure comprising one or more generic fields for a client system of the plurality of client systems in a form specific language by an artificial intelligence (AI) model, including analyzing one or more client forms from the client system by the AI model;
looking up a client configuration of the client system by the AI model; and
determining a relational map between the one or more generic fields in the client form structure for the client system and one or more standard fields in a standard form structure.

2. The method of claim 1, further comprising:
analyzing another client form from the client system by the AI model; and
converting the other client form into the standard form structure based on the relational map.

3. The method of claim 2, further comprising:
printing the one or more generic fields in the other client form as the one or more standard fields in the standard client form based on the relational map.

4. The method of claim 1, wherein said analyzing the one or more client forms from the client system by the AI model comprises identifying the one or more generic fields configured to represent one or more common items in the client form structure by the AI model, and
wherein said determining the relational map comprises mapping between the one or more generic fields in the client form structure and the corresponding one or more standard fields configured to represent the one or more common items in the standard form structure.

5. The method of claim 4, wherein the client form structure is common across the plurality of client systems including a first client system and a second client system of the plurality of client systems identified as a client system field in the client form structure, and
wherein at least one or more generic fields configured to store corresponding one or more common items in the client form structure for the first client system are different from at least one or more generic fields configured to store the corresponding at least one or more items in the client form structure for the second client system.

6. The method of claim 1, further comprising:
determining by the AI model at least one of meaning and context associated with each generic field of the one or more generic fields based on the client configuration.

7. The method of claim 6, wherein said determining the at least one of meaning and context comprises:
analyzing one or more client text strings in each generic field based on the client configuration; and
associating each generic field with the at least one of meaning and context represented by the one or more client text strings.

8. A non-transitory computer-readable storage medium, the computer-readable storage medium including instructions that when executed by a computer, cause the computer to:
receive a plurality of client forms from a plurality of client systems;
evaluate a client form structure comprising one or more generic fields for a client system of the plurality of client systems in a form specific language by an AI model, including analyze one or more client forms from the client system by the AI model;
look up a client configuration of the client system by the AI model; and
determine a relational map between the one or more generic fields in the client form structure for the client system and one or more standard fields in a standard form structure.

9. The computer-readable storage medium of claim 8, wherein the instructions further configure the computer to:
analyze another client form from the client system by the AI model; and
convert the other client form into the standard form structure based on the relational map.

10. The computer-readable storage medium of claim 9, wherein the instructions further configure the computer to:
print the one or more generic fields in the other client form as the one or more standard fields in the standard client form based on the relational map.

11. The computer-readable storage medium of claim 8, wherein said analyze the one or more client forms from the client system by the AI model comprises identify the one or more generic fields configured to represent one or more common items in the client form structure by the AI model, and
wherein said determine the relational map comprises map between the one or more generic fields in the client form structure and corresponding one or more fields configured to represent the one or more common items in the standard form structure.

12. The computer-readable storage medium of claim 11, wherein the client form structure is common across the plurality of client systems including a first client system and a second client system of the plurality of client systems identified as a client system field in the client form structure, and
wherein at least one or more generic fields configured to store corresponding one or more common items in the client form structure for the first client system are different from at least one or more generic fields configured to store the corresponding at least one or more items in the client form structure for the second client system.

13. The computer-readable storage medium of claim 8, wherein the instructions further configure the computer to:
determine by the AI model at least one of meaning and context associated with each generic field of the one or more generic fields based on the client configuration.

14. The computer-readable storage medium of claim 13, wherein said determine the at least one of meaning and context comprises:
analyze one or more client text strings in each generic field based on the client configuration; and
associate each generic field with the at least one of meaning and context represented by the one or more client text strings.

15. A system comprising:
one or more communication interfaces configured to receive a plurality of client forms from a plurality of client systems;
a processor; and
a memory storing instructions that, when executed by the processor, configure the system to:
evaluate a client form structure comprising one or more generic fields for a client system of the plurality of client systems in a form specific language by an AI model, said evaluate including analyze one or more client forms from the client system by the AI model;
look up a client configuration of the client system by the AI model; and
determine a relational map between the one or more generic fields in the client form structure for the client system and one or more standard fields in a standard form structure.

16. The system of claim 15, wherein the instructions further configure the apparatus to:
analyze another client form from the client system by the AI model; and
convert the other client form into the standard form structure based on the relational map.

17. The system of claim 16, wherein the instructions further configure the apparatus to:
print the one or more generic fields in the other client form as the one or more standard fields in the standard client form based on the relational map.

18. The system of claim 15, wherein said analyze the one or more client forms from the client system by the AI model comprises identify the one or more generic fields configured to represent one or more common items in the client form structure by the AI model, and
wherein said determine the relational map comprises map between the one or more generic fields in the client form structure and corresponding one or more fields configured to represent the one or more common items in the standard form structure.

19. The system of claim 18, wherein the client form structure is common across the plurality of client systems including a first client system and a second client system of the plurality of client systems identified as a client system field in the client form structure, and
wherein at least one or more generic fields configured to store corresponding one or more common items in the client form structure for the first client system are different from at least one or more generic fields configured to store the corresponding one or more items in the client form structure for the second client system.

20. The system of claim 15, wherein the instructions further configure the apparatus to:
determine by the AI model at least one of meaning and context associated with each generic field of the one or more generic fields based on the client configuration.

21. The system of claim 20, wherein said determine by the AI model the at least one of meaning and context comprises:
analyze one or more client text strings in each generic field based on the client configuration; and
associate each generic field with the at least one of meaning and context represented by the one or more client text strings.
